(19) United States
(12) Patent Application Publication
(10) Pub. No.: US 2013/0305285 A1
(43) Pub. Date: Nov. 14, 2013

(54) ELECTRONIC PROGRAM GUIDE SUPPORTING ON-DEMAND TV CONTENT

(71) Applicant: Francis Cook, Wimbledon Greater London (GB)

(72) Inventor: Francis Cook, Wimbledon Greater London (GB)

(73) Assignee: LIBERTY GLOBAL EUROPE HOLDING B.V., 1119 PE Schiphol-Rijk (NL)

(21) Appl. No.: 13/700,602

(22) PCT Filed: May 18, 2011
(86) PCT No.: PCT/NL2011/050339

§ 371 Date: Jul. 24, 2013

(30) Foreign Application Priority Data
May 28, 2010 (EP) 10164323.7

(51) Int. Cl. H04N 21/482

(52) U.S. Cl. CPC H04N 21/482
USPC 725/39

(57) ABSTRACT

Method and meta-data search server (MSS 1) for providing services relating to an electronic program guide (EPG). The meta-data search server (1) is in operation in communication with a plurality of data receivers (STB's 3), and one or more meta-data sources (2) which provide program related data. The meta-data search server (1) is connected to a storage unit (9) and arranged to store content description meta-data, the content description meta-data comprising linear scheduling data and on-demand program data.

### FIELD OF THE INVENTION

The present invention relates to a method for providing information in the form of an electronic program guide (EPG), the method comprising storing content description meta-data, the content description meta-data comprising linear scheduling data. In a further aspect, a meta-data search server is provided, as well as a set top box able to communicate with a meta-data search server in operation.

### PRIOR ART

American patent publication US2008/263593 discloses a method for receiving off-air media content from more than one client devices to avoid the confliction of comprehensive program guide at the content distributor. In the Meta-data search server (MSS) side, this document only discloses “a content distributor 202 includes a program guide application 212 having program guide data 214 . . . ” and does not further disclose how the MSS resolves the linear scheduling data and the on-demand program data.

American patent publication US2008/046929 discloses a method for merging more than one contents from the source providers to a user on a scheduled basis or on demand.

European patent application EP-A-2 068 557 discloses a method of aggregating premium content (linear scheduling data) and user content (on-demand content) from one or more agents either locally, nationally or internationally as an EPG file to the user through internet and/or Internet protocol (IP) multicast and/or SMS.

American patent application U.S. Pat. No. 5,751,282 discloses an interactive television system has a centrally located head end server coupled to service multiple, remotely located STB.

In present day television broadcast systems, often use is made of electronic program guides (EPG), which provide to a user information concerning TV programs. EPG-data is transmitted together with TV-signals, nowadays more and more in the form of digital communication.

EPG's or EPG applications in general are designed to allow a user to watch television programs whilst browsing available channel and program information, e.g. for up to eight days ahead. This information can be presented in a multi-channel grid view or a single channel list view on a television screen. The application will allow (where hardware and middleware permits) the setting of reminder memos, recording memos and ongoing recordings for a series of related programmes. Other functionality may include locking/unlocking of channels, setting/unsetting of favourites and signalling of specific channel and program properties (e.g. HD or copy protection).

TV Anytime (TVA) is an ETSI standard for describing TV related broadcast, scheduled and on-demand content, and is used to transfer EPG related data. Despite the formulation of this standard, implementation details are left to the institutions using the standard. TV Anytime is used as an end to end metadata model for transferring data from potential 3rd parties, such as listings providers or other metadata providers (for example on-demand content), into back-end systems of service providers, such as cable operators, all the way through to a set top box (STB) in a consumer's premises in an auditable fashion. The data model associated with TVA is extensive enough to cope with information introduced at a source and can be propagated all the way through to the STB.

### SUMMARY OF THE INVENTION

The present invention seeks to provide an efficient, transparent and easy to implement method to add data relating to on-demand programs in electronic program guide (EPG) systems.

According to the present invention, a method according to the preamble defined above is provided, wherein the content description meta-data further comprises on-demand program data, further comprises creating and storing on-demand program data in the form of an on-demand program instantiation whenever an on-demand program is available for broadcast, the on-demand program instantiation comprising a content identification (CRID) and a locator for each on-demand program, the locator being associated with a physical storage location of the on-demand program data. By including meta-data relating to on-demand program data in the same format as the linear scheduling data, the addition of on-demand programs in an EPG environment is very easy to implement, and transparent. The content identification and locator are included in the stored data in addition to other data already included when using the TV Anytime standard, such as MPEG2, resolution, HD, . . . . This allows to have all EPG data needed to implement on-demand programming available at a central location, allowing effective dissemination of (parts of) the data, and efficient use of resources involved in the system (bandwidth, storage, etc.).

Compared to the prior art documents mentioned above, the key point of the present invention is to implement the linear scheduling data and the on-demand program data in an associated semantic format, i.e. TV Anytime format, and integrate/encapsulate them from the same metadata source into one content (program information) in an EPG file, thus provide a common way to access the data irrespective of the client use. This idea unifies the standard of deriving metadata from multiple vendors. Therefore, the process of adding VOD data to EPG system is more efficient, transparent, and easier to implement. In this manner, both the linear scheduling instantiation and the on-demand program instantiation comprise a unique content identification (CRID) and a locator that can be resolved by the MSS, which provide the same scheme for indicating the location of the data source providers (see examples on page 9, lines 13-25 of present patent application). In addition, the identification item of one or more purchase group defined in the content can provide a purchasing method which can be displayed in the terminals, such as “free to view” or “free to air” or the relevant price for the VOD data. Moreover, the MSS acts as the central CRID authority/resolution and therefore provides relatively efficient deployment/dissemination of the data source providers, and efficient use of resources involved in the system (bandwidth, storage, etc.) as described below.

In an embodiment, the content description meta-data is stored as an EPG-file (e.g. in the form of an XML document), the content description meta-data and the on-demand program data being stored as separate tables of data (Program Information Table, VoD Package Table) in the EPG-file. Addition of an additional table with on-demand program data is possible and easy to implement in an EPG file, especially when using XML formatted data.

The method further comprises in an embodiment, sending the EPG file for reception by one or more set top boxes, the EPG-file comprising the content identification (CRID) of the on-demand program instantiation. The content identification and other data needed for assembling and displaying the EPG is thus effectively disseminated from a central location to a large number of set top boxes. The data sent is sufficient for preparing and populating the required view of the EPG at the end-user.

In a further embodiment, the method further comprises using the content identification for resolving a locator associated with the content identification using the stored program instantiations. The content identification may be selected by an end-user, and sent from a set top box to the centrally located meta-data search server. This enables location resolution, allowing to retrieve the actual video data associated with an on-demand program when selected by a user of a set top box.

In an even further embodiment, the method may further comprise storing an identification of one or more of a plurality of purchase groups. The concept of purchase groups adds an additional layer of information in the EPG content meta-data, allowing very user-friendly selection of groups of programs, e.g. involving series of TV-programs.

In a further aspect, the present invention relates to a meta-data search server for providing services relating to an electronic program guide (EPG), the meta-data search server in operation being in communication with a plurality of data receivers (i.e. set top boxes), and one or more meta-data sources which provide program related data, the meta-data search server being connected to a storage unit and arranged to store content description meta-data, the content description meta-data comprising linear scheduling data and on-demand program data. Furthermore, the meta-data search server may further be arranged to execute the present invention method embodiments.

In an even further aspect, the present invention relates to a set top box for receiving program related data including an electronic program guide for display on a display unit, the set top box being arranged to be in communication with a meta-data search server according one of the invention embodiments, to receive an EPG file, and to convert the data comprised in the EPG file for display on the display unit.

In a further embodiment, the set top box is further arranged to allow selection of an on-demand program, and to send the content identifier associated with the selected on-demand program to the meta-data search server for resolving the actual location of the on-demand program for retrieval thereof.

A computer program product is described in an even further aspect of the present invention, comprising computer executable instructions, which when loaded on a computer system, provide the computer system with the functionality of the present invention method embodiments.

### SHORT DESCRIPTION OF DRAWINGS

The present invention will be discussed in more detail below, using a number of exemplary embodiments, with reference to the attached drawings, in which

FIG. 1 depicts a schematic diagram of a part of a television broadcast system wherein the present invention is embodied;

FIG. 2 depicts a block diagram detailing a model as used in an embodiment of the present invention; and

FIG. 3 depicts a schematic view of an EPG file as used in present invention embodiments.

### DETAILED DESCRIPTION OF EXEMPLARY EMBODIMENTS

TV Anytime (TVA) is an ETSI standard for describing TV related broadcast, scheduled and on-demand content, and is used to transfer electronic program guide (EPG) related data. Despite the formulation of this standard, implementation details are left to the institutions using the standard. TVA is used as an end-to-end meta-data model for transferring data from potential 3^{rd} parties into back-end systems of service providers, such as cable operators, all the way through to the set top box (STB) in a consumer's premises in an auditable fashion. The data model associated with TVA is extensive enough to cope with information introduced at a source and can be propagated all the way through to the STB.

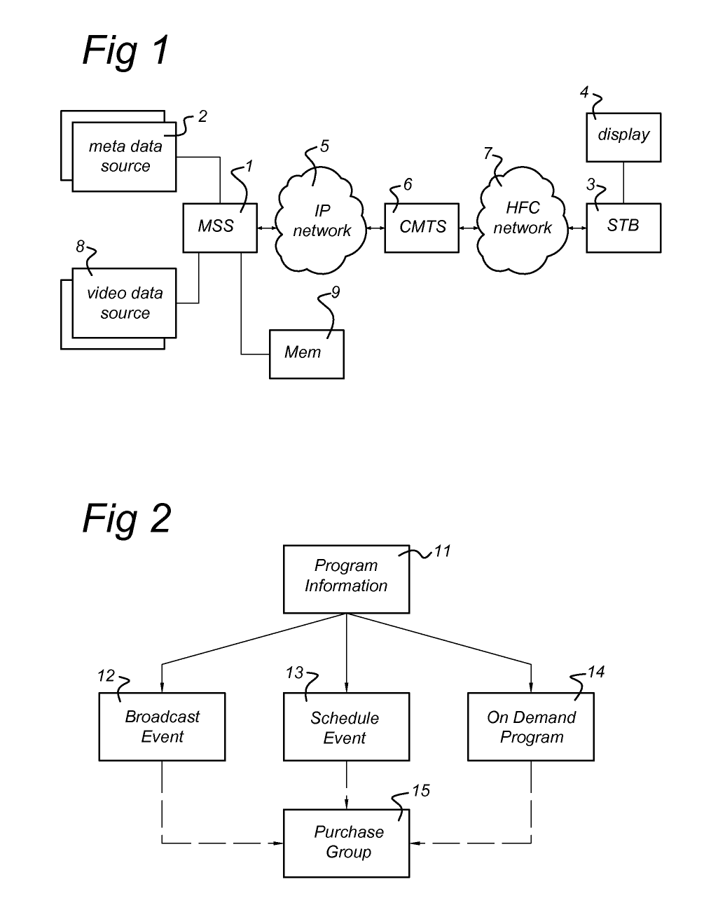

In FIG. 1, a simplified schematic diagram of part of a television broadcast system is shown, in which the hardware/software entities, related structures and data flow are exemplified which are used in the present invention embodiments. A major element in this set-up is the meta-data search server (MSS) 1, which receives and collects data relating to available programs from third parties such as TV broadcast companies, e.g. from one or more meta-data sources 2. The MSS 1 is connected to a memory unit 9 for storing data. At the other end of the system shown in FIG. 1, a plurality of set top boxes (STB) 3 are present, which are located remote from the MSS 1, e.g. in consumer's premises, and connected to displays 4, such as television sets. The STB 3 provides functionality in order to allow a user of the STB 3 to make selections of channel etc. for viewing, and to display an electronic program guide (EPG) on the display 4.

According to an embodiment of the present invention, a MSS 1 is provided for providing services relating to an EPG, the MSS 1 in operation being in communication with a plurality of data receivers (i.e. STB's) 3, and one or more meta-data sources 2 which provide program related data, the MSS 1 being connected to a storage unit 9 and arranged to store content description meta-data, the content description meta-data comprising linear scheduling data and on-demand program data.

The connection between the MSS 1 and the STB's 3 is via a transmission network, which allows to transfer data in both directions. Most data will be transferred downstream (to the STB 3), but it is possible to transfer data upstream (i.e. from STB 3 to MSS 1), which allows enhanced user interaction, e.g. personalisation of video on demand (VoD) programming. In the exemplary embodiment shown in FIG. 1, the MSS 1 connects to an IP network 5, to which also a cable modem termination system (CMTS) 6 is connected. The CMTS 6 and the STB 3 are connected to each other via a hybrid fibre-coaxial network 7, which is readily available in most rural areas. Of course, other types of network connections may be used, such as an all IP network 5.

The MSS 1 is also connected to one or more sources of video data 8, e.g. in the form of a database. The sources of video data 8 may also be embodied as dedicated links to several sources local to and/or remote from the MSS 1, such as storage media or (live) data feeds from content providers. The content can be processed in order to be streamed using transmission schemes (not part of the present invention and known as such) to eventually reach the STB's 3.

The TVA standard provides a specification for describing metadata associated with TV Content that is either broadcast or made available in an on-demand (Video on Demand (VoD) or Near Video on Demand (NVoD)) context. Implementation of the standard is not within the scope of the specification. Neither is the associated semantic intent for any VoD or Linear model, which means that the meaning and use for any model based on TV Anytime must be created. This might lead to problems when constructing a system made from components from multiple vendors, since a “(Commercial) Off The Shelf” System (or COTS) will not contain the same intent in the use of the standard as another because there is no standard usage model or pattern defined.

The MSS 1 as shown in the embodiment of FIG. 1 is a focal point for all the meta-data associated with any content eventually available to the consumer via STB 3. The present invention embodiments provide a solution to provide basic now and next information as well as TV Schedule Listings and on-demand catalogues for Electronic Programme Guides (EPG) to be shown on the display 4 using the STB 3. Furthermore, the data may be used to feed data to Point of Sale Portals for on-demand (and NVoD or Pay Per View) content (e.g. using Internet based portals). For this document, a Linear programme is a program whose broadcast and playback is controlled by the broadcaster itself (and made available through e.g. a cable company), and an on-demand Programme is one where the consumer can request and control playback interactively using the STB 3.

In order to provide the solution, a common set of semantics is defined to create a meta-data model that encompasses both the linear broadcast and on demand domains and to provide a common way to access the data irrespective of the client use. Thus, according to an embodiment of the present invention, a method is given for providing information in the form of an electronic program guide (EPG), the method comprising storing content description meta-data, the content description meta-data comprising linear scheduling data, wherein the content description meta-data further comprises on-demand program data. According to a further embodiment, the method further comprises sending the EPG file for reception by one or more set top boxes 3, the electronic program guide file comprising the content identification (CRID) of the on-demand program instantiation.

Searching for content using a STB 3 connected by e.g. a cable company may yield a mixture of programmes that are broadcast or only available on-demand. In addition the model encapsulates pricing, availability, and categorisation data to allow to drive navigation functions of the STB 3 and to support the business requirements present in a converged platform provider (i.e. broadcast and on-demand programs).

The model as used in the present invention embodiments is shown schematically in FIG. 2 and can be described in general terms as comprising three layers. In the top layer a box is shown comprising a piece of content 11 (Program Information) as obtained from one of the meta-data sources 2 (see FIG. 1). This content can be processed by the MSS 1 into one or more of three possible types of instantiation, i.e. a Broadcast Event instantiation 12 (This is an instance of a program that is to be broadcast but may not be part of a schedule, such as a channel); a Schedule Event instantiation 13 (An instance that is part of a channel's broadcast schedule); and an On-Demand Program instantiation 14 (An on-demand instance of a program).

In addition each type of instantiation 12-14 has attributes specifying content formatting (MPEG2, resolution, HD etc.), location (file, network). The key addition of knowledge in this general embodiment is in the relationship between the instances 12-14 and the content 11.

In a further embodiment, further knowledge is added by using Purchase Groups 15, which form a third layer of the model. These Purchase Groups 15 may be used to define purchasing and editorial relationships (e.g. series, or other editorial demarcation). These relationships are created by the business owners and are also able to be created automatically e.g. in the form of Catch-up TV Content where a linear programme is also later available as an on-demand programme.

An instance 12-14 of a program is created by the MSS 1 whenever a program can be offered to a consumer via the STB 3. For a Broadcast or Schedule event, the instance 12, 13 will correspond to the programme being available on a specified channel at a specified time and optionally via a group 15 which defines a purchasing method. Instances 12-14 that do not require purchasing can be referenced directly or for the sake of consistency added to a “purchase group” 15 that reflects the business aspect of being ‘Free to Air’ or ‘Free to View’. An instance 12-14 has a defined availability or content timeframe that defines when it can be physically available to the STB 3 of the consumer. This meta-data will then drive the point of sale for the consumer, whether it is through search which is available as a function on the STB 3 or some other application portal (e.g. using Internet).

In other words, in an embodiment of the present invention, the method comprises creating and storing on-demand program data in the form of an on-demand program instantiation whenever an on-demand program is available for broadcast, the on-demand program instantiation comprising a content identification (CRID) and a locator for each on-demand program, the locator being associated with a physical storage location of the on-demand program data.

The purchasing by a customer using the STB 3 is defined in this embodiment by using the groups 15 in a manner similar to what is usually referred to as Channel Bundles (a group of channels which can be selected for viewing after payment). These “purchase groups” 15 can comprise any number of instances 12-14 which can be purchased together, e.g. using a selection mechanism implemented in the STB 3, with relevant data being sent back to the MMS 1). Because a programme 11 may have many instances 12-14, there are many ways to define a group 15 including:
Broadcast content—e.g. sports events or NVoD, repeated event instances will reference the same group.
Series content—episodic content.
Genre related, or content that is only available for particular time periods e.g. Every Wednesday, or 7 day catch-up.

Group availability can be defined outside of the content timeframe, so a customer can e.g. purchase a group 15 that contains every episode of Lost, without having to define all the episodes up front. This mechanism works with the local digital rights management (DRM) solution by allowing for DRM to be defined either at a programme level or per purchasable instance 12-14 (more usual). The availability is determined by the date range attached to the price, and the appropriate price is the one that matches the region in which the data is presented, allowing for multiple price points for each territory that the content is valid in.

Additionally as these groups 15 are uniquely identifiable they can be used as references within existing billing systems (in communication with the MSS 1) and can represent part of a wider consumer product if required.

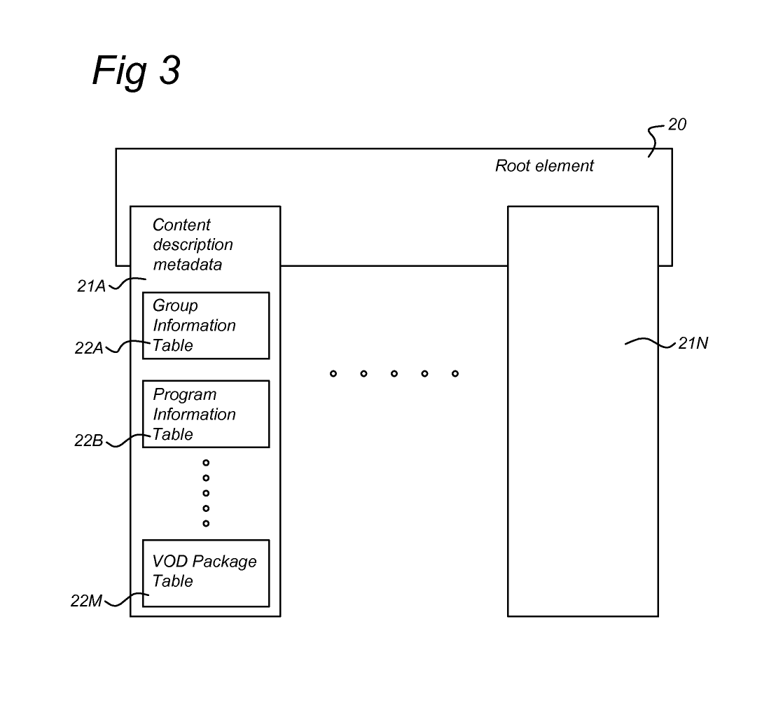

In practical applications, the data relating to program information 11, instantiations 12-14 and groups 15 is composed by the MSS 1 using data originating from the meta data sources 2 (see FIG. 1). The data is composed into a eXtensible Markup Language (XML) document which has a structure as given in FIG. 3 (only the parts relevant for the present embodiments are shown).

The XML document comprises a root element 20, which includes data and descriptors to be able to process the XML document throughout the chain from MSS 1 up unto the STB 3. The metadata in the XML document is furthermore divided in a number of areas 21A . . . 21N (e.g. content metadata 21A, instance description meta-data, consumer meta-data, etc.). The content meta-data area 21A comprises a number of tables 22A . . . 22M which comprise further relevant data. In the present invention embodiments, a VoD Package table 21M is included in the XML document to allow a STB 3 to present VoD data in an EPG, and to allow selection of a VoD instance 14 and proper retrieval or linking to the associated source 8 of the VoD video data. Thus, in an embodiment of the present invention, a method is provided wherein the content description meta-data is stored as an EPG file, the content description meta-data and the on-demand program data 10 being stored as separate tables of data 22B, 22M in the EPG-file.

The retrieval of the proper programmes for viewing using the STB 3 is made possible in the present embodiment using a combination of content identification data (CRID) and resolution scenarios implemented in the STB 3 and MSS 1, using information provided in the XML document. A CRID is a unique content identifier, and the resolution scenarios comprise the process of finding content (the data forming one or more programs) by finding content locators (the sources of video data 8) based on a CRID, using content locators.

A software program being executed on the STB 3 on which the XML document comprising areas 21 and tables 22 has been downloaded from the MSS 1, is arranged to again use the MSS 1 as a resolution service provider for finding content locators based on the CRID's. CRID's can resolve to the following types of locators:
1. Broadcast TV channel event:—identified by a DVB (Digital Video Broadcast) service triplet, event identification and start time. This data can be used e.g. to tune an RF tuner (in the STB 3 or in the display unit 4 in order to receive the broadcast program. An example of such a locator is:
dvb://033a.0f04.123f;4504@2008-01-17T12:30:00Z.
2. Video on Demand product:—identified by a product Id which can be used during set up of VoD sessions to receive the on-demand program in the STB 3. Example of such a locator is:
   vod://643344.

The information required to perform resolution is found in the EPG and VoD schedule metadata, respectively, which will both be available to the MSS 1. The MSS 1 will act as the CRID authority as well as resolution service provider for the STB 3, in addition to its role as the focal meta-data delivery server. Thus, in an embodiment of the present invention, the method further comprises using the content identification for resolving a locator associated with the content identification using stored program instantiations 12-14.

CRIDs may take a form like crid://lgi.com/<data>

where <data> will be a unique identifier for the (broadcast or VoD) program, group or VoD package.

As stated above, the software being executed in the STB 3 will use the MSS 1 as resolution service provider for such CRIDs, in order to retrieve the locator having e.g. the format: <transport mechanism>:<transport system specific>

Note that resolution of group CRIDs, typically used to identify series, normally will result in multiple program CRIDs, and that different CRIDs (typically a series CRID and an episode CRID) can resolve to the same locator in the sources of video data 8. In the same manner VoD package CRIDs will resolve to one or more program CRIDs.

An example of CRIDs and locators are given in the following table:

| Type | CRID | Locator |
|---|---|---|
| Broadcast program | crid://lgi.com/3454533 | dvb://033a.0f04.- |
| | | 123f;4504@2008-01- |
| | | 17T12:30:00Z |
| VoD program | crid://lgi.com/v23552 | upcvod://643344 |
| Broadcast series | crid://lgi.com/s456233 | Resolves to broadcast |
| | | program CRIDs |
| VoD package | crid://lgi.com/p67324 | Resolves to VOD |
| | | program CRIDs |

Aspects of the present invention may be implemented with a distributed computer system operating environment, together providing e.g. the functionality of the MSS 1. In a distributed computing environment, tasks may be performed by remote computer devices that are linked through communications networks. The distributed computing environment may include client and server devices that may communicate either locally or via one or more computer networks. Embodiments of the present invention may comprise special purpose and/or general purpose computer devices that each may include standard computer hardware such as a central processing unit (CPU) or other processing means for executing computer executable instructions, computer readable media for storing executable instructions, a display or other output means for displaying or outputting information, a keyboard or other input means for inputting information, and so forth. Examples of suitable computer devices include hand-held devices, multiprocessor systems, microprocessor-based or programmable consumer electronics, networked PCs, minicomputers, mainframe computers, and the like.

Some of the invention embodiments have been described above in the general context of computer executable instructions, such as program modules, that are executed by a processing device, which is part of the MSS 1 or the STB 3. Generally, program modules include routines, programs, objects, components, data structure definitions and instances, etc., that perform particular tasks or implement particular abstract data types. Typically the functionality of the program modules may be combined or distributed as desired in various environment.

Embodiments within the scope of the present invention also include computer readable media having executable instructions. Such computer readable media can be any available media that can be accessed by a general purpose or special purpose computer. By way of example, and not limitation, such computer readable media can comprise RAM, ROM, EEPROM, CD-ROM or other optical disk storage, magnetic disk storage or other magnetic storage devices, or any other medium which can be used to store the desired executable instructions and which can be accessed by a general purpose or special purpose computer. Combinations of the above should also be included within the scope of computer readable media. Executable instructions comprise, for example, instructions and data which cause a computer system (e.g. a general purpose computer, special purpose computer, or special purpose processing device) to perform a certain function or group of functions.

The present invention has been described above using a detailed description of embodiments, with reference to the attached drawings. In these embodiments, elements may be replaced by equivalent elements providing a similar functionality. The scope of the invention is determined by the language of the claims as attached and its equivalents. The used reference signs are referring to the embodiments described above and are not intended to limit the scope of the claims in any manner.

What is claimed is:

1. A method for providing information in the form of an electronic program guide (EPG), the method comprising storing content description meta-data, the content description meta-data comprising linear scheduling data, wherein the content description meta-data further comprises on-demand program data, further comprising creating and storing on-demand program data in the form of an on-demand program instantiation whenever an on-demand program is available for broadcast, the on-demand program instantiation comprising a content identification (CRID) and a locator for each on-demand program, the locator being associated with a physical storage location of the on-demand program data.

2. The method of claim 1, wherein the content description meta-data is stored as an EPG file, the content description meta-data and the on-demand program data being stored as separate tables of data in the EPG file.

3. The method of claim 1, further comprising
sending the EPG file for reception by one or more set top boxes (STB), the EPG file comprising the content identification (CRID) of the on-demand program instantiation.

4. The method of claim 3, further comprising
using the content identification for resolving a locator associated with the content identification using stored program instantiations.

5. The method of claim 1, further comprising
storing an identification of one or more of a plurality of purchase groups.

6. A meta data search server (MSS) for providing services relating to an electronic program guide (EPG), the meta-data search server in operation being in communication with a plurality of data receivers (STB's), and one or more meta-data sources which provide program related data, the meta-data search server being connected to a storage unit and arranged to store content description meta-data, the content description meta-data comprising linear scheduling data and on-demand program data, and further arranged for creating and storing on-demand program data in the form of an on-demand program instantiation whenever an on-demand program is available for broadcast, the on-demand program instantiation comprising a content identification (CRID) and a locator for each on-demand program, the locator being associated with a physical storage location of the on-demand program data.

7. (canceled)

8. A set top box for receiving program related data including an electronic program guide (EPG) for display on a display unit, the set top box being arranged to be in communication with the meta-data search server of claim 6, to receive an EPG file, and to convert the data comprised in the EPG file for display on the display unit.

9. The set top box according to claim 8, the set top box being further arranged to allow selection of an on-demand program, and to send the content identifier associated with the selected on-demand program to the meta-data search server for resolving the actual location of the on-demand program for retrieval thereof.

10. A computer program product comprising computer executable instructions, which when loaded on a computer system, provide the computer system with the functionality of the method according to claim 1.
